(19) United States
(12) Patent Application Publication
(10) Pub. No.: US 2011/0175309 A1
(43) Pub. Date: Jul. 21, 2011

(54) STROLLER BASKET

(75) Inventor: Daniel Nelson Newhard, Lititz, PA (US)

(73) Assignee: CHICCO USA, INC., Lancaster, PA (US)

(21) Appl. No.: 12/688,396

(22) Filed: Jan. 15, 2010

(51) Int. Cl. B62B 3/02

(52) U.S. Cl. 280/47.35

(57) ABSTRACT

A stroller having a movable basket assembly with a basket frame pivotally connected to a stroller frame, a basket release mechanism disposed between the basket frame and a lower cross member of the stroller frame, and a basket fabric attached to the basket frame. The basket release mechanism includes a plunger, an actuator, and a spring associated with the plunger and actuator. The plunger has an engagement end that engages a corresponding groove of a link connected to the lower cross member. The actuator is movable between a first position, in which the plunger is engaged with the groove, to a second position, in which the plunger can be disengaged from the groove, in order to move the basket frame between an upper position and a lower position.

### FIELD OF INVENTION

This application is generally related to strollers having storage baskets and more particularly related to strollers having a movable frame to improve user access.

### BACKGROUND

Child strollers with baskets for holding items are well known in the art. In many strollers, the basket is located underneath the child's seat and accessible from an opening at the rear of the stroller. However, in strollers with a reclining child seat, when the seat is fully reclined it becomes difficult to access the basket as the seatback blocks the opening to the basket. Therefore, a need exists for a stroller basket that can be easily accessed even when the top of the basket is blocked, such as by a seat or reclined seatback of the stroller.

### SUMMARY

A stroller having a movable basket assembly is disclosed, the stroller includes a stroller frame having at least one front leg, a left rear leg, a right rear leg, and a handlebar connected to the at least one front leg or the left and right rear legs. The movable basket assembly includes a basket frame movably connected to the stroller frame, the basket frame being movable relative to the stroller frame between an upper position and a lower position. The stroller may further include a cross rail connected to the left and right rear legs and a basket release mechanism disposed between the basket frame and the cross rail. The basket release mechanism includes a body having a first end connected to the basket frame and a second end. A plunger having first and second ends is connected to the body, the second end of the plunger being removably engaged with a receiving member connected to the cross rail. A spring adjacent to the plunger biases the second end of the plunger into engagement with the receiving member to maintain the basket frame in the upper position. An actuator is connected to the plunger and is movable against the spring to remove the second end of the plunger from the receiving member to move the basket frame to the lower position.

In other embodiments of the stroller, the basket frame may include a fabric retention channel, and a complementary attachment member incorporated with a basket fabric is positioned within the fabric retention channel. The fabric retention channel may be formed with a pair of inwardly extending lips that support the complementary attachment member within the fabric retention channel. The basket fabric may extend through a spacing between the pair of inwardly extending lips.

A stroller is also disclosed, the stroller having a frame with at least one front leg, a left rear leg, a right rear leg, and an operator handle having a left support rail and a right support rail connected to the left and right rear legs, respectively. Each of the legs has a respective wheel mounted thereto. The stroller also includes a seat supported by the stroller frame, the seat having a seatback pivotally connected to the frame and adapted to move between an upright position and a reclined position. The stroller further includes a movable basket assembly having a basket frame pivotally connected to the stroller frame, a basket release mechanism disposed between the basket frame and a lower cross-member arranged between the left and right rear legs, and a basket fabric attached to the basket frame. The basket release mechanism includes a tubular body having a first end and a second end, with a release handle and an attachment element arranged at the first end of the tubular body. The release handle is adapted to move between first and second positions, and the attachment element is connected to the basket frame. A spring is arranged inside of the tubular body. A plunger associated with the release handle is arranged inside of the tubular body adjacent the spring, the plunger having an engagement end that extends from the second end of the tubular body when the release handle is in the first position. A linkage is arranged at the second end of the tubular body, the linkage having a groove that corresponds to the engagement end of the plunger and an end portion connected to the lower cross-member.

For sake of brevity, this summary does not list all aspects of the present invention, which is described in further detail below.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangement shown in the drawings.

FIG. 1 is a perspective view of an embodiment of the stroller having a movable basket assembly with the basket frame in an upper position and illustrating a complementary infant travel seat that can be engaged with the stroller.

FIG. 2 is a fragmentary right elevational view of the stroller shown in FIG. 1, with the basket frame in an intermediary position.

FIG. 3 is a fragmentary right elevation view of the stroller shown in FIG. 1, with the basket frame shown in a lower position.

FIG. 4 is an exploded view of the basket release mechanism of the movable basket assembly of the stroller shown in FIG. 1.

FIG. 5 is a cross-sectional view of the basket release mechanism of the movable basket assembly shown in FIG. 1 taken along line 5-5 of FIG. 1, showing the basket release mechanism in a rest position.

FIG. 6 is a cross-sectional view of the basket release mechanism of the movable basket assembly shown in FIG. 1, showing the basket release mechanism in an activated position.

FIG. 7 is a cross-sectional view of the basket frame taken along line 7-7 of FIG. 3.

### DETAILED DESCRIPTION OF THE PREFERRED EMBODIMENTS

Certain terminology is used in the following description for convenience only and is not limiting. The words “front,” “rear,” “upper,” “lower,” “left,” and “right” designate directions in the drawings to which reference is made. The words “inwardly” and “outwardly” refer to directions toward and away from the parts referenced in the drawings.

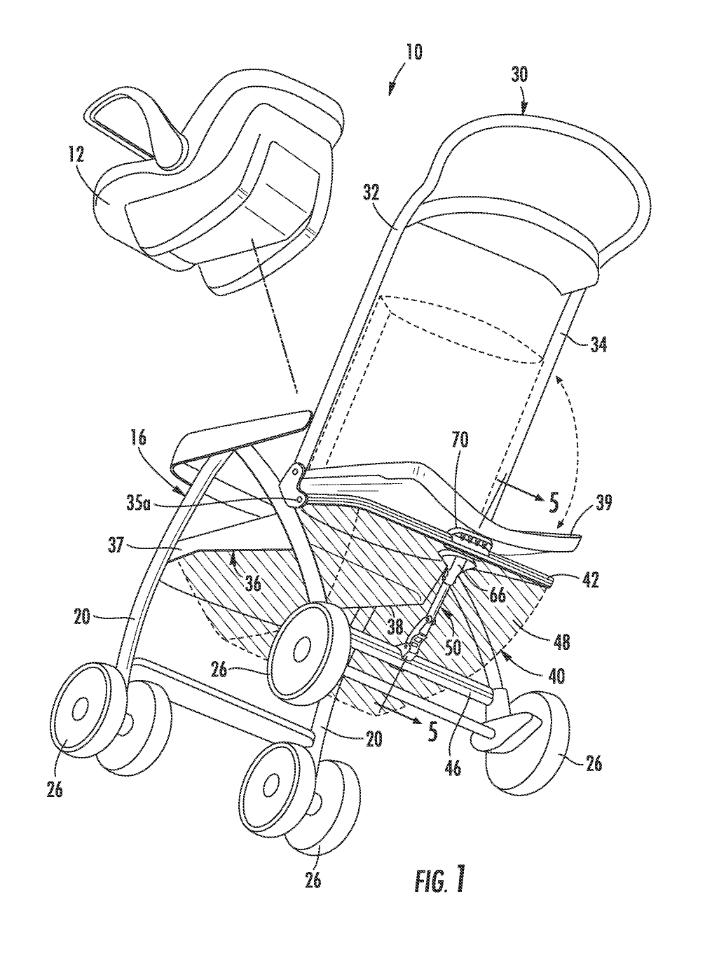

FIG. 1 shows an embodiment of the stroller 10 having a movable basket assembly 40 according to the present invention, with a complementary infant travel seat 12 that can be engaged with the stroller 10. The stroller 10 has a stroller frame 16 made up of at least one front leg 20, a left rear leg 22, a right rear leg 24, and an operator handle 30 having a left support rail 32 and a right support rail 34 connected to the left and right rear legs, respectively. Each of the legs 20, 22, 24 has a respective wheel 26 mounted thereto. The stroller 10 may also include a seat 36 supported by the stroller frame 16, the seat 36 having a seatback 39 connected to the seat 36 or stroller frame 16 and adapted to move between an upright position (as shown in phantom in FIG. 1) and a reclined position (as shown in FIG. 1). The stroller 10 further includes a movable basket assembly 40 having an upper basket frame 42 movably connected to the stroller frame 16 and a basket release mechanism 50 disposed at the rear of the stroller 10 between the upper basket frame 42 and a lower cross-member 46 arranged between the left and right rear legs 22, 24. The upper basket frame 42 can be U-shaped and is connected to left and right portions of the stroller frame 16 such that it pivots relative to the stroller frame 16. Thus, the upper basket frame 42 can be connected to, without limitation, the left and right rear legs 22, 24, the left and right support rails 32, 34, or the left and right side members 37, 38 of the seat 36. One of ordinary skill in the art will recognize that the upper basket frame 42 can be connected to the stroller frame using left and right pivot pins 35a, 35b (as shown in FIGS. 1-3) or any other movable connection, including, without limitation, a ball and socket joint or hinge connection. A basket fabric 48 (shown transparent in FIG. 1) is attached to the upper basket frame 42 and forms the body or storage compartment of the movable basket assembly 40. The basket fabric 48 may also be connected to one or more of the lower cross-member 46, the left and right side-members 37, 38 of the seat 36, or any other portion of the stroller frame 16 to maintain its shape.

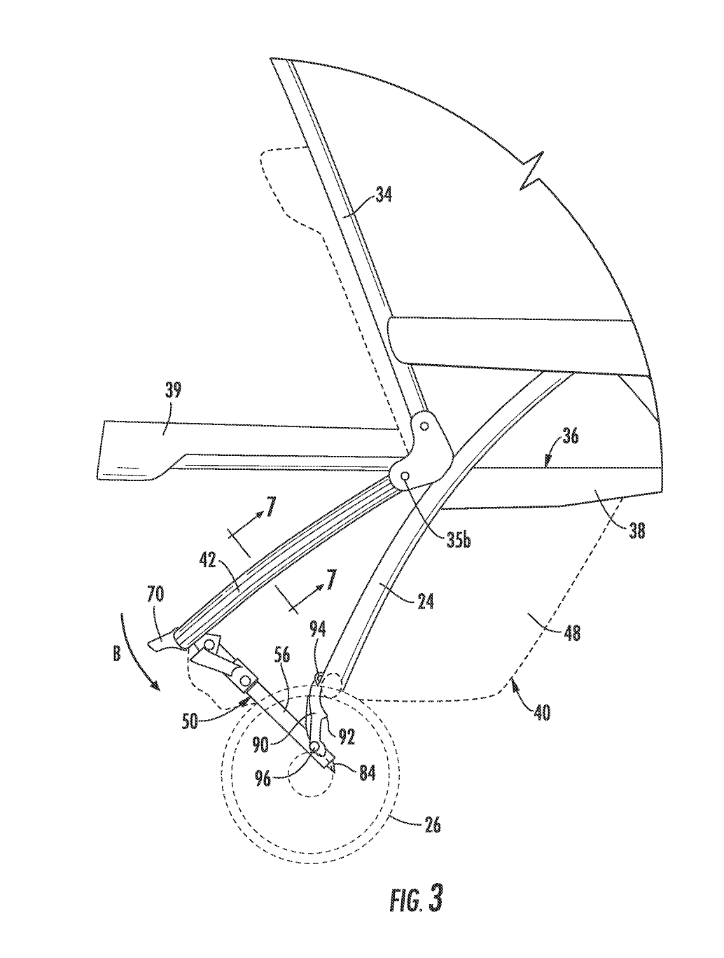

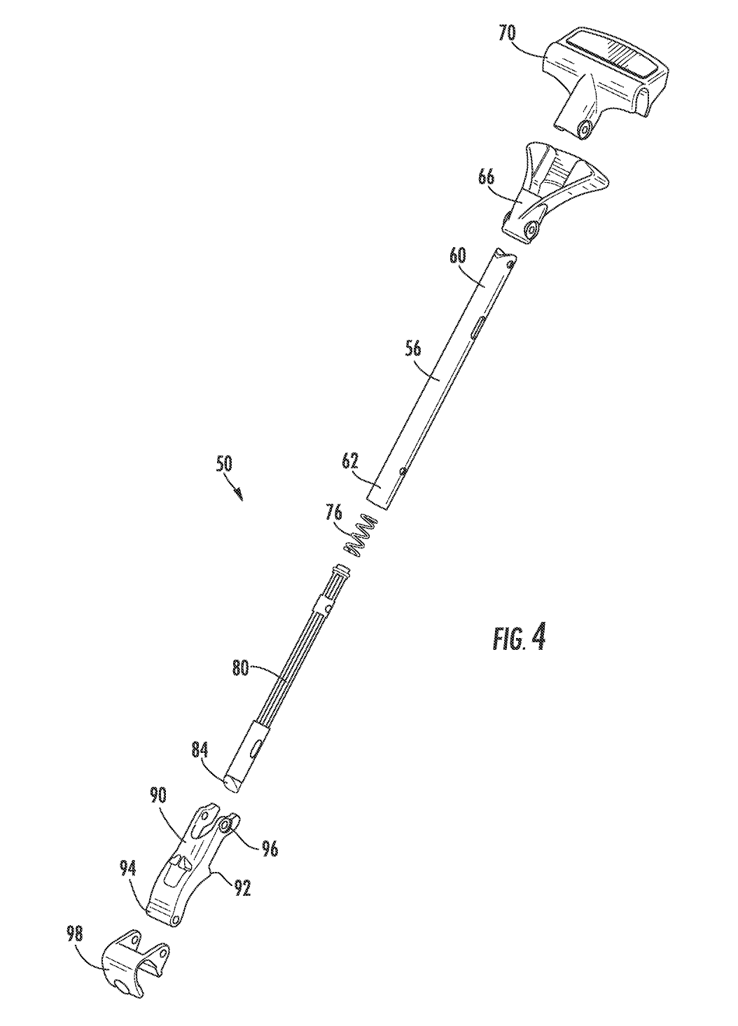

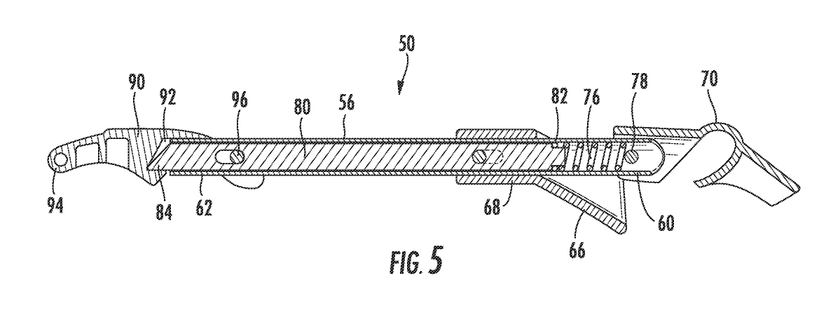

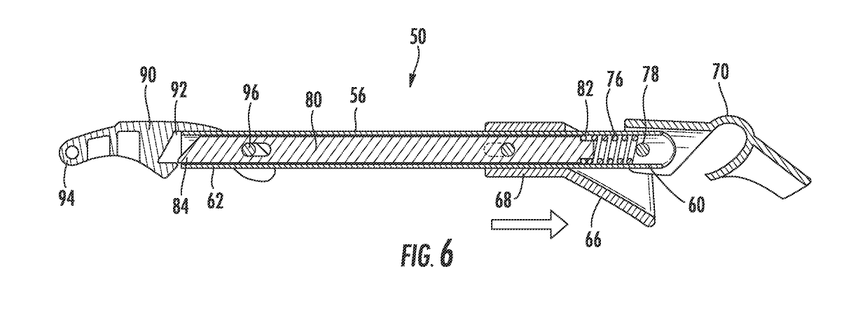

As shown in FIGS. 4-6, the basket release mechanism 50 includes a tubular body 56 having a first end 60 and a second end 62. The tubular body may be made of any suitable material, including, without limitation, aluminum, steel, graphite, or plastic tubing. An actuator, such as a release handle 66, and an attachment element 70 are arranged at the first end 60 of the tubular body 56. The attachment element 70 is connected to the upper basket frame 42, and can be secured to the upper basket frame using, without limitation, a fastener, adhesive, or friction fit. The release handle 66 is adapted to move between a rest position (as shown in FIG. 5) and an activated position (as shown in FIG. 6). A spring 76 is arranged inside of the tubular body 56, and a plunger 80 associated with the release handle 66 is arranged inside of the tubular body 56 adjacent to the spring 76. A plunger 80 is positioned within the tubular body 56 and has a lower end 84 that extends from the second end 62 of the tubular body 56 when the release handle 66 is in the rest position. A link 90 is movably connected to the second end 62 of the tubular body 56 to form a movable connection with the lower cross-member 46. The link 90 has a groove 92 that seats the lower end 84 of the plunger 80 and an end portion 94 connected to the lower cross-member 46. As shown in FIGS. 4 and 5, the lower end 84 of the plunger 80 can be tapered to form a secure connection with the groove 92 when the release handle is in the rest position (FIG. 5), and to permit the lower end 84 to easily re-engage the groove 92 when the lower end 84 is disassociated from the groove 92 (such as when movable basket assembly 40 is moved from a lower position (FIG. 3) back to an upper position (FIG. 1)). A support member 98 can be secured to the lower cross-member 46 and provide a pivotal connection between the end portion 94 of the link 90 and the lower cross-member 46.

As shown in FIG. 5, the release handle 66 can be formed with a hollow portion 68 arranged concentrically about the tubular body 56. The spring 76 can be positioned between an upper end surface 82 of the plunger 80 and a fixed member 78 at the first end 60 of the tubular body 56. The fixed member 78 can be, for example, a bolt that connects the attachment member 70 to the tubular body 56. As shown in FIG. 6, when the release handle 66 is moved in an axial direction towards the first end 60 of the tubular body 56 to the activated position, the plunger 80 moves along with the release handle 66, compressing the spring 76 and causing the lower end 84 of the plunger 80 to disengage from the corresponding groove 92 of the link 90. The link 90 may be pivotally connected to the tubular body 56 at a pivot point 96, with an axis of rotation perpendicular to a longitudinal axis of the tubular body 56.

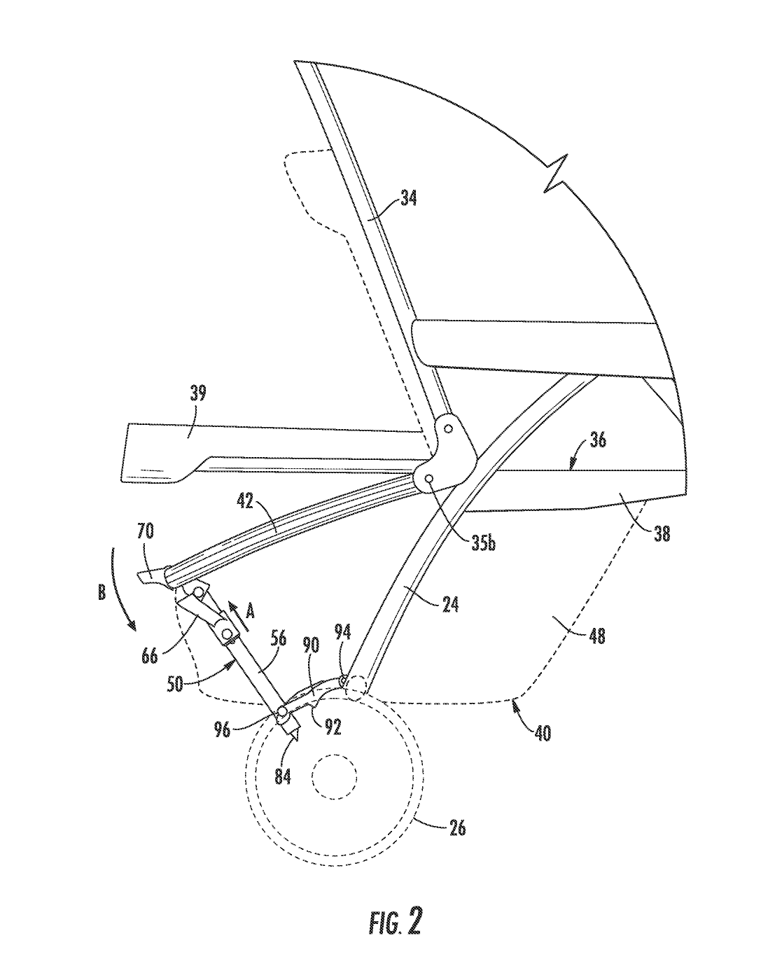

As shown in FIGS. 1 and 5, when the release handle 66 is in the rest position and the lower end 84 of the plunger 80 is secured within the corresponding groove 92 of the link 90, the movable basket assembly 40 is in an upper position. In this position, the storage compartment of the movable basket assembly 40 can be easily accessed when the seatback 39 is in an upright position (as shown in phantom lines in FIGS. 1-3). However, when the seatback 39 is in a reclined position, as shown in FIG. 1, the opening to the storage compartment of the movable basket assembly 40 formed by the upper basket frame 42 is blocked by the seatback 39 and difficult for a user to access. Using the basket release mechanism 50 to move the movable basket assembly 40 into a lower position allows a user to access the storage compartment of the movable basket assembly 40 without having to move the seatback 39 into its upright position. As shown in FIGS. 2 and 3, the release handle 66 can be brought into the activated position by moving it in the direction of arrow A. When the release handle 66 is in the activated position, the lower end 84 of the plunger 80 is disassociated from the groove 92 of the link 90 which permits the plunger 80 and tubular body to pivot relative to the link 90, and the link 90 to pivot relative to the lower cross-member 46. This in turn permits the upper basket frame to be pivoted in the direction of arrow B to the lower position. FIG. 2 shows the movable basket assembly 40 in an intermediary position between the upper position and the lower position. FIG. 3 shows the movable basket assembly 40 in the lower position, where further rotation of the upper basket frame 42 is prevented by contact between the link 90 and the tubular body 56. In either of these positions, a user can easily access the storage compartment of the movable basket assembly 40 while the seatback 39 is in its fully reclined position.

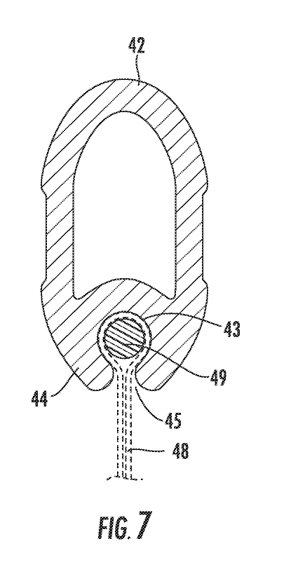

As shown in FIG. 7, the upper basket frame 42 can include a fabric retention channel 43, which allows a complementary basket attachment member 49 incorporated with or attached to the basket fabric 48 to be inserted therein. This arrangement allows the basket fabric 48 to be attached to the upper basket frame 42 without the use of snaps, loops, or other fastening means. The fabric retention channel 43 may be formed with a pair of inwardly extending lips 44 that support the basket attachment member 49 within the fabric retention channel 43. The basket fabric 48 can extend through a spacing 45 between the pair of inwardly extending lips 44 and hang from the upper basket frame 42. The basket attachment member 49 may be formed from plastic or any other suitable material, and should have a cross-sectional area such that the basket attachment member 49 and the surrounding portion of the basket fabric 48 can both fit in the fabric retention channel 43 without slipping out through the spacing 45 between the pair of inwardly extending lips 44. Although not illustrated in the drawings, the lower cross-member 46, the left and right side-members 37, 38, or the seat 36 may also include fabric retention channels 43 for attaching the basket fabric 48.

While various methods, configurations, and features of the present invention have been described above and shown in the drawings, one of ordinary skill in the art will appreciate from this disclosure that any combination of the above features can be used without departing from the scope of the present invention. It is also recognized by those skilled in the art that changes may be made to the above described methods and embodiments without departing from the broad inventive concept thereof. While the movable basket assembly 40 has been described above with reference to the basket release mechanism 50 and link 90, one of ordinary skill in the art would understand that the other mechanisms can be used within the spirit of this application to permit the upper basket frame 42 to move between the upper and lower positions. For example, a spring or piston could be positioned directly between the upper basket frame 42 and the lower cross-member 46 to permit the upper basket frame to move between the upper and lower positions.

What is claimed is:

1. A stroller having a movable basket assembly, the stroller comprising:
a stroller frame having at least one front leg, a left rear leg, a right rear leg, and a handlebar connected to the at least one front leg or the left and right rear legs; and the movable basket assembly comprising:
a basket frame movably connected to the stroller frame, the basket frame being movable relative to the stroller frame between an upper position and a lower position.

2. The stroller of claim 1, further comprising:
a cross rail connected to the left and right rear legs;
a basket release mechanism disposed between the basket frame and the cross rail, the basket release mechanism comprising:
a body having a first end connected to the basket frame and a second end;
a plunger connected to the body, the plunger having a first end and a second end removably engaged with a receiving member connected to the cross rail;
a spring adjacent to the plunger that biases the second end of the plunger into engagement with the receiving member to maintain the basket frame in the upper position; and
an actuator connected to the plunger, the actuator movable against the spring to remove the second end of the plunger from the receiving member to move the basket frame to the lower position.

3. The stroller of claim 2, wherein the actuator is a handle movable between a rest position in which the plunger is engaged with the receiving member, and an activated position in which the plunger is disengaged from the receiving member.

4. The stroller of claim 3, wherein the plunger and the spring are arranged at least partially inside of the body.

5. The stroller of claim 4, wherein the second end of the plunger is tapered and extends from the second end of the body when the handle is in the rest position, and the second end of the plunger is drawn into the body when the handle is in the activated position.

6. The stroller of claim 2, wherein a link connects the second end of the body to the cross rail, the link having a first end pivotally connected to the second end of the body and a second end pivotally connected to the cross rail, the receiving member is arranged on the link.

7. The stroller of claim 2, wherein the body has a tubular shape and the actuator is arranged concentrically about the body, the actuator is movable in an axial direction along the body towards the first end of the body between a rest position and an activated position.

8. The stroller of claim 2, wherein the spring is positioned between the first end of the plunger and a fixed member connected to the first end of the body, the spring is compressed as the actuator is moved from a rest position to an activated position.

9. The stroller of claim 1, wherein the basket frame has a fabric retention channel, and a complementary attachment member incorporated with a basket fabric is positioned within the fabric retention channel.

10. The stroller of claim 9, wherein the fabric retention channel has a pair of inwardly extending lips that support the complementary attachment member within the fabric retention channel, and the basket fabric extends through a spacing between the pair of inwardly extending lips.

11. The stroller of claim 1, wherein the basket frame is pivotally connected to the left and right rear legs of the stroller.

12. The stroller of claim 1, wherein the handlebar has left and right support rails, and the basket frame is pivotally connected to the left and right support rails.

13. A stroller comprising:
a stroller frame having at least one front leg, a left rear leg, a right rear leg, each of the legs having a respective wheel mounted thereto, an operator handle having a left support rail and a right support rail connected to the left and right rear legs, respectively;
a seat supported by the stroller frame, the seat having a seatback pivotally connected to the stroller frame and adapted to move between an upright position and a reclined position; and
a movable basket assembly comprising a basket frame pivotally connected to the stroller frame, a basket release mechanism disposed between the basket frame and a lower cross-member arranged between the left and right rear legs, and a basket fabric attached to the basket frame, the basket release mechanism comprising:
a tubular body having a first end and a second end;
a release handle and an attachment element arranged at the first end of the tubular body, the release handle adapted to move between first and second positions, the attachment element connected to the basket frame;
a spring arranged inside of the tubular body;
a plunger associated with the release handle and arranged inside of the tubular body adjacent the spring, the plunger having an engagement end that extends from the second end of the tubular body when the release handle is in the first position; and
a linkage arranged at the second end of the tubular body, the linkage having a groove that corresponds to the engagement end of the plunger and an end portion connected to the lower cross-member.

14. The stroller of claim 13, wherein the plunger is engaged with the groove when the release handle is in the first position and the plunger disengages from the groove when the release handle is in the second position.

15. The stroller of claim 14, wherein the basket frame is in an upper position when the plunger is engaged with the groove and the basket frame is movable to a lower position when the plunger is disengaged from the groove.
